(19) United States
(12) Patent Application Publication
(10) Pub. No.: US 2008/0185348 A1
(43) Pub. Date: Aug. 7, 2008

(54) Methods and apparatus for treating cyanide- and/or complexing-agent-containing solutions

(75) Inventors: Gerhard Gutekunst, Karlsruhe (DE); Waldemar Mzyk, Calw (DE)

Correspondence Address: IP GROUP OF DLA PIPER US LLP, ONE LIBERTY PLACE, 1650 MARKET ST, SUITE 4900, PHILADELPHIA, PA, 19103, US

(73) Assignee: Wieland Dental + Technik GmbH & Co. KG, a corporation of Germany, Pforzheim (DE)

(21) Appl. No.: 12/002,642

(22) Filed: Dec. 17, 2007

(30) Foreign Application Priority Data
Dec. 19, 2006 (DE) 102006062387.8

(51) Int. Cl. C02F 1/02

(52) U.S. Cl. 210/766; 210/180; 210/179

(57) ABSTRACT

A method of treating an aqueous cyanide- and/or complexing-agent-containing solution, including high-temperature treating the solution in a closed reaction vessel, discharging at least a portion of the treated solution from the reaction vessel, at least partially replacing the discharged fraction with untreated solution, and subjecting the untreated solution to high-temperature treatment along with a treated-solution fraction remaining in the reaction vessel.

### RELATED APPLICATION

This application claims priority of German Patent Application No. 102006062387.8, filed Dec. 19, 2006, herein incorporated by reference.

### TECHNICAL FIELD

This disclosure relates to methods of treating an aqueous cyanide- and/or complexing-agent-containing solution, possibly containing heavy and/or precious metals, and to apparatus for implementing such methods.

### BACKGROUND

Cyanides, heavy metals and/or precious metals, in particular in complex formation, for example, in the form of cyanide, EDTA, NTA, DTPA and NTMP complexes, and the corresponding complexing agents are frequently to be found in waste water which occurs, for example, in separating or screening plants.

For reasons relating to environmental protection, such waste water cannot readily be disposed of. Much interest has therefore already been focused on reprocessing and/or cleaning such waste water. Such reprocessing should comprise the degradation of complexing agents contained in the waste water and, in particular, also cyanide detoxification, where necessary. Furthermore, it is, of course, desirable, in particular in the case of waste water containing precious metals to recover the metals from the waste water, e.g., to recover gold from gold bars.

EP 0 655 416 discloses a method of treating waste water of the type mentioned above in which cyanides and complexing agents are degraded by high-temperature alkaline hydrolysis in an autoclave, with ammonium formate being developed in the process. The method described in EP 0 655 416 is distinguished in that the autoclave used for the hydrolysis is assigned a regulating circuit, the partial water-vapor pressure in the autoclave being recorded and kept constant via a controllable outlet-regulating valve such that, once a desired partial water-vapor pressure value corresponding to the predetermined reaction temperature has been exceeded, steam is discharged, for pressure-reducing purposes, via the outlet-regulating valve. Precious and/or heavy metals contained in the treated waste water are precipitated out during the hydrolysis and can be removed from the base of the autoclave once the reaction has been completed.

EP 0 655 416 provides an overview of selected prior art relating to the treatment of cyanide-containing waste water, including U.S. Pat. No. 5,256,313, U.S. Pat. No. 5,160,637 and DE 30 11 650.

U.S. Pat. No. 5,256,313 discloses an apparatus and a method in which cyanide-containing waste water is treated at high temperatures, in a closed reactor, until the cyanide contained has been reacted essentially in full. Thereafter, the solution is cooled and then discharged.

U.S. Pat. No. 5,160,637 discloses treatment of cyanide-containing waste water at elevated temperature in a flow reactor. The cyanide-containing solution is led through an essentially vertically oriented, elongate reactor, the liquid in the reactor moving quickly. The cyanide contained is hydrolyzed here to form non-toxic and degradable ammonium formate.

DE 30 11 650 discloses, from the standpoint of recovering gold from liquids containing gold cyanide compounds, a method according to which the liquids in the alkaline medium are heated to temperatures around 170° C. That method, which takes place in a conventional high-pressure reactor, also results in the formation, inter alia, of ammonia.

### SUMMARY

We provide a method of treating an aqueous cyanide- and/or complexing-agent-containing solution, including high-temperature treating the solution in a closed reaction vessel, discharging at least a portion of the treated solution from the reaction vessel, at least partially replacing the discharged fraction with untreated solution, and subjecting the untreated solution to high-temperature treatment along with a treated-solution fraction remaining in the reaction vessel.

We also provide an apparatus that performs the method, including at least one closed reaction vessel that carries out the high-temperature treatment, at least one storage tank downstream of the reaction vessel or vessels that has an outlet for steam and gaseous reaction products, and at least one heat exchanger downstream of the storage tank.

### BRIEF DESCRIPTION OF THE DRAWING

FIG. 1 is a block-diagram-like illustration of a selected apparatus. The FIGURE illustrates the following schematically:

B1: charge tank for storing a cyanide-containing solution which is to be treated;

C1: reaction vessel for a first high-temperature treatment of the cyanide-containing solution;

C2: further reaction vessel for carrying out a second high-temperature treatment;

C3: storage tank in which solution treated in the reaction vessels C1 and C2 is cooled;

B2: collecting tank for collecting gaseous reaction products and steam (in condensed form) discharged from the storage tank C3;

B3: collecting tank for collecting treated (detoxified) solution which has been discharged from the storage tank C3;

W1: heating unit in the reaction vessel C1;

W2: heating unit in the reaction vessel C2;

W3: heat exchanger which is arranged downstream of the storage tank C3 and is intended for using residual heat from the gaseous reaction products discharged from the storage tank C3, and in particular the steam from C3, and the cyanide-containing solution to be treated coming from the charge tank B1 is preheated by the residual heat prior to being introduced into the reaction vessel C1;

W4: further heat exchanger, which is arranged downstream of the storage tank C3 and is intended for using residual heat from the treated (detoxified) solution discharged from the storage tank C3;

W5: heat exchanger in which cyanide-containing solution stored in the charge tank B1 can be preheated;

P1: pump for transferring untreated cyanide solution from the charge tank B1 in the reaction vessel C1;

P2: pump between the heat exchangers W4 and W5;

V1-V7: valves;

C4: collecting tank in which steam and gases discharged from the reaction vessels C1 and C2 via an outlet-regulating valve (V5 and V6) can be stored on an interim basis; and

C5: combustion catalyst in which gases from C4 can be burnt without leaving any residues.

### DETAILED DESCRIPTION

It will be appreciated that the following description is intended to refer to specific examples of structure selected for illustration in the drawings and is not intended to define or limit the disclosure, other than in the appended claims.

Our methods are suitable for treating both an aqueous cyanide-containing and an aqueous complexing-agent-containing solution. The solutions are preferably alkaline solutions. Of course, it is also possible to treat solutions which contain both cyanides and complexing agents. In particular, the methods are also suitable for treating solutions containing heavy and/or precious metals. If heavy and/or precious metals are contained in the solution which is to be treated, they are present, in particular, in complex formation.

The methods comprise, in particular, a high-temperature treatment of the solution in a closed reaction vessel. During the high-temperature treatment, the cyanide, complexing agents and/or metallic complexes contained in the solution are hydrolyzed at least partially or, in some preferred forms of the method, also fully.

The method is distinguished, in particular, in that following the high-temperature treatment, only some of the treated solution is discharged from the reaction vessel. The discharged fraction is preferably then at least partially, preferably fully, replaced by untreated solution. The mixture of the newly fed, untreated solution and the already treated solution remaining in the reaction vessel can then be subjected to further high-temperature treatment in a further step.

As an alternative, or in addition, the method is distinguished, in particular, in that following the high-temperature treatment, the discharged fraction of the treated solution, or else all the treated solution, is transferred into a storage tank arranged downstream of the reaction vessel and is then cooled therein. Cooling takes place here, in particular, by virtue of steam and gaseous reaction products being discharged from the storage tank.

This procedure contrasts with EP 0 655 416. In that method, aqueous cyanide-and/or complexing-agent-containing solutions possibly containing heavy and/or precious metals are always treated in a reaction vessel until the reaction has been completed essentially in full. Subsequently, the treated solution is cooled in the reaction vessel and only discharged when the temperature of the solution has dropped below a certain value. It is only once all the solution has been discharged that new, untreated solution is introduced into the reaction vessel. The reaction vessel and the new solution can then be brought to reaction temperature again to carry out a further high-temperature treatment.

In contrast, our method is advantageous in many respects. For example, the method is superior from an energy-related standpoint. By virtue of the actual reaction and cooling operations being separated in space, the residual heat of the reaction vessel is available without limitation for the purpose of heating subsequently fed untreated solution. In particular, even the mere partial replacement of treated solution by untreated solution is advantageous in energy terms. The residual heat of the reaction vessel and the residual heat of the treated-solution fraction remaining in the reaction vessel contribute to the situation where the mixture of already treated and newly fed untreated solution need only be brought to the optimum reaction temperature from a considerably elevated temperature level. The absolute temperature fluctuations in the reaction vessel between two high-temperature treatments are at a correspondingly considerably lower level than in EP 0 655 416.

This, in turn, also has an extremely positive effect on the service life of the reaction vessel since pronounced temperature fluctuations may very well lead to the material being subjected quickly to fatigue.

In our method, the steam and the gaseous reaction products and/or the cooled solution, for energy recovery, are/is fed to at least one heat exchanger arranged downstream of the storage tank. Steam and gaseous reaction products are preferably fed to a heat exchanger via which untreated solution can be preheated prior to being introduced into the reaction vessel. The residual heat from the cooled solution may be recovered, if appropriate, via a further heat exchanger. This likewise serves preferably for preheating untreated solution.

It is preferred if, following the high-temperature treatment, between about 5% and about 95% of the treated solution is discharged from the reaction vessel. It is particularly preferred if between about 25% and about 75%, in particular, approximately about 50%, is discharged from the reaction vessel. In the latter case, replacing the discharged about 50% of the solution in full by untreated solution results in a temperature being established in the reaction vessel which corresponds approximately to the average between the temperature of the untreated solution and the temperature of the solution remaining in the reactor.

The high-temperature treatment preferably takes place at a temperature between about 150° C. and about 300° C. A temperature between about 220° C. and about 260° C. is further preferred. The high-temperature treatment is preferably carried out at a temperature of approximately about 240° C. The precise temperature is basically unimportant, although there is a relationship between the temperature selected and the speed of reaction (hydrolysis). The temperature should usually not therefore drop below about 150° C. since, otherwise, the reaction takes too long. The higher the temperature selected, the higher is the resulting pressure in the closed reaction vessel. The vessel has to be of correspondingly pressure-resistant design, which, in the case of very high pressures, may be associated with high costs. The high-temperature treatment thus does not usually take place above about 300° C.

The high-temperature treatment preferably takes place at a pressure between about 5 bar and about 90 bar, preferably between about 30 bar and about 50 bar, in particular at approximately about 40 bar. As has been mentioned, the pressure is usually related directly to the temperature selected.

As has likewise already been mentioned, in preferred forms, the solution which is to be treated, prior to entering into the reaction vessel, is preheated. In particular, heating to a temperature between about 120° C. and about 180° C. is preferred. The solution is particularly preferably preheated to a temperature of approximately about 150° C. This takes place, in particular, by way of thermal energy which can be recovered by at least one heat exchanger arranged downstream of the reaction vessel, in particular the already mentioned heat exchanger by means of which energy can be recovered from the gaseous reaction products and from the steam discharged from the storage tank and/or from the cooled solution discharged from the storage tank.

In particularly preferred forms, the discharged fraction of the treated solution is fed to at least one further reaction vessel and subjected to further high-temperature treatment therein. The at least one further reaction vessel is arranged, in particular, upstream of the storage tank. The discharged fraction of the treated solution, in the at least one further reaction vessel, preferably replaces a corresponding volume of likewise already treated solution.

Forms of the method having at least one further reaction vessel likewise have great advantages from an energy-related point of view. The solution which is fed to the at least one further reaction vessel is already at reaction temperature, in which case considerably less energy is to be used for heating purposes here than in the upstream reaction vessel, in which the solution is subjected to high-temperature treatment for the first time.

It may thus be particularly advantageous to arrange two or more reaction vessels in series, in which case complexing agents and/or cyanides contained in the solution are usually only partially hydrolyzed in the first reaction vessel, and the hydrolysis is then completed in the at least one further reaction vessel. Energy for heating purposes, then, is present predominantly just in the first reaction vessel, whereas what is essentially required in the at least one further reaction vessel is for the temperature to be maintained.

For heating purposes, the reaction vessels are preferably each provided with a heating means/heater.

It is preferred if the solution in the reaction vessel and, if appropriate, also in the at least one further reaction vessel and/or in the at least one storage tank is continuously mixed, in particular agitated. This ensures that a substantially homogenous temperature distribution is achieved in the vessels/tanks, and that solids which have been precipitated out, such as heavy or precious metals, can be kept in suspension and removed with the detoxified solution. It is then possible, for example using filtration, for the solids which have been precipitated out to be separated off, and collected, in particular downstream of the downstream storage tank.

The reaction vessels are preferably autoclaves. These are produced in particular in pressure-resistant form from stainless steel to be possible to compensate for the pressures occurring during the high-temperature treatment.

A reaction vessel which can be used is preferably provided with a regulating circuit as described in EP 0 655 416. This makes it possible for the steam pressure in the autoclave to be recorded and kept constant via a controllable outlet-regulating valve such that, once a defined difference in pressure between the reaction vessel and water reservoir has been exceeded, steam and/or gases are/is discharged, for pressure-reducing purposes, via the outlet-regulating valve. The steam discharged and/or the gases discharged may possibly still contain impurities such as cyanides. Discharged gases are preferably fed to a catalytic combustion. Discharged steam can be condensed and returned directly or indirectly into a reaction vessel for further treatment.

Suitable storage tanks are in the form, in particular, of thermally insulated tanks, in which case heat cannot escape in an uncontrolled manner.

The storage tank and the reaction vessel, if appropriate also the at least one further reaction vessel, are connected via lines, which are likewise preferably thermally insulated. The feed lines and discharge lines are preferably provided with valves via which the inflow and the outflow of the solution can be regulated. All the valves are preferably controllable, in which case the method can be implemented fully automatically.

The method is particularly preferably executed quasicontinuously. This is intended to mean that, at defined time intervals (namely in each case following a high-temperature treatment of defined duration), untreated solution is introduced into the reaction vessel where it replaces already treated solution, which then, in turn, is transferred directly or indirectly into the storage tank or which possibly, prior to being transferred into the storage tank, is transferred into at least one further reaction vessel, and likewise replaces already treated solution there, and all these operations are repeated continuously.

In a particularly preferred form of treating an aqueous cyanide- and/or complexing-agent-containing solution, possibly containing heavy and/or precious metals, the solution is subjected to high-temperature treatment in two or more closed reaction vessels arranged in series. Following the high-temperature treatment, some of the treated solution is discharged from each of the at least two reaction vessels, the discharged fraction being replaced by untreated solution or treated solution from the upstream reaction vessel. This is followed by a further high-temperature treatment step, the individual steps, as mentioned above, being repeated preferably continuously.

It is preferred if the discharged fraction of the treated solution from the final reaction vessel of the series is transferred into a downstream storage tank and cooled. This takes place, as has been mentioned above, in particular by virtue of steam and gaseous reaction products being discharged from the storage tank. In a further step, for energy recovery, these may be fed to at least one heat exchanger arranged downstream of the storage tank. Preferred forms of the individual method steps have already been described above.

We also provide an apparatus for implementing a method as has already been described in detail above. The apparatus comprises at least one reaction vessel, but in particular at least two series-connected reaction vessels, for carrying out a high-temperature treatment. Furthermore, the apparatus comprises at least one storage tank which is arranged downstream of the reaction vessel(s) and has an outlet for steam and gaseous reaction products, and it further comprises, in particular, at least one heat exchanger arranged downstream of the storage tank. Preferred forms of the individual components have already been described in detail above.

In a particularly advantageous configuration of the apparatus, an ammonium-recovery installation is arranged downstream of the storage tank. In this installation, ammonia which is discharged from the storage tank can be absorbed and collected for subsequent reuse.

As has already been mentioned, the reaction vessels and/or the storage tank preferably have means for continuously mixing the solution contained therein. The continuous-mixing means may be, in particular, agitators.

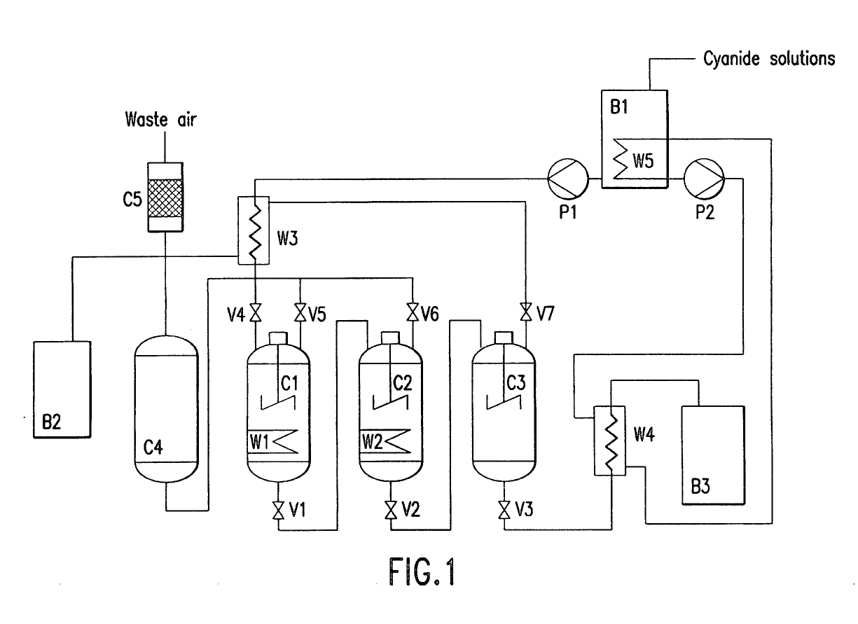

Further features of the methods and apparatus can be gathered from the following description of selected aspects of the method and the apparatus and from FIG. 1. It is possible for the individual features to be realized on their own, or in combination with one another, in a selected form. The particular forms described serve merely for explanatory purposes, and to give a better understanding, and are not to be understood as being in any way restrictive.

FIG. 1 describes one way in which our methods are implemented as follows:

By means of the high-pressure pump P1, cyanide-containing waste water preheated to 80 to 90° C. is transferred from the charge tank B1, via the heat exchanger W3, into the reaction vessel C1. In the heat exchanger W3, the cyanide-containing waste water is preheated to approximately 150° C., in which case the hydrolysis reaction can begin as quickly as possible in the reaction vessel C1. The heating unit W1 in the reaction vessel C1 heats the cyanide-containing waste water to approximately 240° C. The pressure in the reaction vessel is regulated as described in EP 0 655 416, the subject matter of which is incorporated by reference. The main reaction of the cyanides contained in the waste water takes place in the reaction vessel C1. Gases produced are led away, and washed out, as described in EP 0 655 416. In particular, they are fed to the collecting tank C4 and, via the latter, to the combustion catalyst C5, in which the gases can be burned without leaving residues.

Once the main reaction has taken place, the valve V1 is opened, whereupon about half the contents of the reaction vessel C1 are delivered, as a result of the positive pressure produced in the reaction vessel, into the reaction vessel C2 (if appropriate a corresponding volume of treated solution is discharged beforehand from the reaction vessel C2). The freed volume in the reaction vessel C1 is refilled with the high-pressure pump P1 via the heat exchanger W3, with cyanide-containing waste water preheated to about 150° C. The temperature in the reaction vessel C1 drops to an average temperature of approximately 190° C. to 200° C. The heating unit W1 can quickly increase the temperature to about 240° C. again.

In the reaction vessel C2, the heating unit W2 maintains the temperature at about 240° C. for a further at least about 1.5 hours. Pressure regulation takes place, once again, as described in EP 0 655 416. The reaction is then complete and, once the valve V2 has been opened, about half the contents of the reaction vessel C2 are transferred into the storage tank C3 as a result of the positive pressure produced in the reaction vessel C2.

By virtue of the valve V7 on the storage tank C3 being opened, some of the contents of the storage tank C3 are distilled off (discharged as steam), until the contents remaining in the storage tank C3 have thus cooled to approximately 150° C. The steam phase is cooled in the heat exchanger W3 and gives off its condensation enthalpy to the cyanide-containing waste water which is simultaneously led via the heat exchanger W3 and fills the reaction vessel C1. The condensate is a relatively clean ammonia solution which is accommodated in the collecting tank B2 for further use. By virtue of the valve V3 being opened, the contents remaining in the storage tank C3 (the treated solution cooled to approximately 150° C.) are emptied into the collecting tank B3 via the heat exchanger W4, via which the residual heat from the contents can be passed on, via the heat exchanger W5, to the contents of the charge tank B1 or to other consuming units.

The storage tank C3 is then refilled with half the contents of the reaction vessel C2, the reaction vessel C2, for its part, is refilled with half the contents of the reaction vessel C1, and the reaction vessel C1, in turn, is filled with untreated solution from the charge tank B1. The cycle can then begin anew.

1. A method of treating an aqueous solution containing complexing-agents comprising:
treating the solution in a closed reaction vessel at high-temperature;
discharging at least a portion of the treated solution from the reaction vessel;
at least partially replacing the discharged fraction with untreated solution; and
subjecting the untreated solution to high-temperature treatment along with the treated-solution fraction remaining in the reaction vessel.

2. The method of claim 1, wherein the aqueous solution contains precious metals.

3. The method of claim 1, wherein the aqueous solution contains heavy metals.

4. The method of claim 1, further comprising:
transferring the treated solution into a storage tank downstream of the reaction vessel following the high-temperature treatment;
cooling the treated solution; and
discharging steam and gaseous reaction products from the storage tank.

5. The method of claim 4, further comprising:
feeding the steam and the gaseous reaction products, for energy recovery, to at least one heat exchanger downstream of the storage tank.

6. The method of claim 4, further comprising feeding cooled solution, for energy recovery, to at least one heat exchanger downstream of the storage tank.

7. The method of claim 1, further comprising:
transferring the discharged fraction of the treated solution into a storage tank downstream of the reaction vessel;
cooling the discharged fraction of the treated solution; and
discharging steam and gaseous reaction products from the storage tank.

8. The method of claim 7, further comprising feeding the steam and the gaseous reaction products, for energy recovery, to at least one heat exchanger downstream of the storage tank.

9. The method of claim 7, further comprising feeding the cooled solution, for energy recovery, to at least one heat exchanger downstream of the storage tank.

10. The method of claim 1, further comprising discharging between 5% and 95% of the treated solution from the reaction vessel.

11. The method of claim 1, further comprising discharging between 25% and 75% of the treated solution from the reaction vessel.

12. The method of claim 1, wherein the high-temperature treatment takes place at a temperature between 150° C. and 300° C.

13. The method of claim 1, wherein the high-temperature treatment takes place at a temperature between 220° C. and 260° C.

14. The method of claim 1, wherein the high-temperature treatment takes place at a pressure between 5 bar and 90 bar.

15. The method of claim 1, wherein the high-temperature treatment takes place at a pressure between 30 bar and 50 bar.

16. The method of claim 1, further comprising preheating the solution to be treated to a temperature between 120° C. and 180° C. prior to entering into the reaction vessel.

17. The method of claim 16, wherein the solution to be treated is preheated by way of energy which is recovered by at least one heat exchanger downstream of the reaction vessel.

18. The method of claim 1, wherein the discharged fraction of the treated solution is fed to at least one further reaction vessel and is subjected to further high-temperature treatment.

19. The method of claim 4, wherein the discharged fraction of the treated solution is fed to at least one further reaction vessel upstream of the storage tank and is subjected to further high-temperature treatment.

20. The method of claim 7, wherein the discharged fraction of the treated solution is fed to at least one further reaction vessel upstream of the storage tank and is subjected to further high-temperature treatment.

21. The method of claim 18, wherein the discharged fraction of the treated solution, in the at least one further reaction vessel, at least partially replaces the solution which has already been treated.

22. The method of claim 1, wherein the solution in the reaction vessel is continuously mixed.

23. The method of claim 1, wherein the reaction vessel used is an autoclave.

24. The method of claim 1, wherein it is executed quasicontinuously.

25. The method according to claim 18, wherein the solution is subjected to high-temperature treatment in at least two closed reaction vessels arranged in series, some of the treated solution is discharged, following the high-temperature treatment, from each of the at least two reaction vessels, the discharged fraction is replaced by untreated solution or treated solution from the upstream reaction vessel, and the high-temperature treatment is repeated.

26. The method of claim 25, further comprising transferring the discharged fraction of the treated solution from the final reaction vessel of the series into a downstream storage tank;
cooling the discharged fraction; and
discharging steam and gaseous reaction products from the storage tank.

27. The method of claim 26, further comprising feeding the steam and gaseous reaction products, for energy recovery, to at least one heat exchanger downstream of the storage tank.

28. The method of claim 26, further comprising feeding the cooled solution, for energy recovery, to at least one heat exchanger downstream of the storage tank.

29. An apparatus that performs the method of claim 1, comprising at least one closed reaction vessel that carries out the high-temperature treatment, at least one storage tank downstream of the at least one reaction vessel and having an outlet for steam and gaseous reaction products, and at least one heat exchanger downstream of the at least one storage tank.

30. The apparatus of claim 29, comprising at least two closed reaction vessels, operatively connected in series.

31. The apparatus of claim 29, further comprising an ammonium-recovery installation downstream of the storage tank.

32. The apparatus of claim 29, wherein the at least one reaction vessel has a continuous-mixer.

33. The apparatus of claim 29, wherein the at least one storage tank has a continuous-mixer.
